(19) United States
(12) Patent Application Publication
(10) Pub. No.: US 2009/0298030 A1
(43) Pub. Date: Dec. 3, 2009

(54) Use of Ultrasound Imaging equipment in classroom as a teaching aid

(76) Inventor: Muhammad Rizwan Haider, Houston, TX (US)

Correspondence Address: Muhammad R. Haider, 918 Knotty Elmwood Tr, Houston, TX, 77062, US

(21) Appl. No.: 12/131,032

(22) Filed: May 30, 2008

(51) Int. Cl. G09B 23/28

(52) U.S. Cl. 434/262

(57) ABSTRACT

The inventive process named SWITCH is a unique teaching aid for students and teachers of biology to help them better understand the basic concepts and remove the ambiguities left behind by traditional teaching methods. It utilizes a portable ultrasound machine in a class room setting to obtain real time images of internal organs of human/animal body and project them on a big screen while the audience watches. The images so produced are not only vivid and multidimensional but also carry information like organ size, shape, texture, position and physical relationship to other organs in the body. In case of heart and blood vessels the real time images demonstrate exact function of chambers and valves and flow of blood in color from arterial to venous tree. The technique aims at fortifying truthful concepts of systems in a living body from the very basic to advanced levels of biology education. It has been developed in accordance with curricular guidelines for various levels and therefore has different modules dedicated to those levels (high school, colleges, universities, technical training institutes and other professional training institutions). Modules are based on chapters of respective recommended text books and can be utilized at the beginning, during or at the end of a chapter.

### BROAD STATEMENT

The invention/concept relates to a novel use of ultrasound imaging equipment to serve as a teaching aid for biology students at all levels of their education. Currently ultrasound machines are being used for educational purpose only to train specialist physicians and new ultrasound technologists. And even in those fields the use is limited to train individuals for diagnostic purposes and in hospital department setting only. Ironically the use has not filtered down to even benefit students of medical schools in general. The purpose of our patent is to:
1. Use portable ultrasound machine as teaching aid
2. For the purpose of building and strengthening true concepts.
3. For students, professionals and researchers in the fields of general biology and its subclasses e.g. anatomy, physiology, pathology, surgery etc.
4. At all levels of education i.e. high school, college, university, technical schools, vocational training schools researchers and other professional institutes

### BACKGROUND INFORMATION

### History of Teaching Aids

Educators use teaching aids to impart and emphasize information, stimulate interest, and facilitate the learning process. They range from simple to sophisticated and can be aural, visual, or increasingly more frequently, computerized. The blackboard was one of the very first and has traditionally been one of the most widely-used teaching aids. It was patented in 1823 by Samuel Read Hall of Concord, Vt., a Congregational minister who founded the Concord Academy to train teachers in “school keeping”. Initially teachings aids were primarily visual and included globe, boards (bulletin, flannel, and magnetic), models, photographs, drawings, specimens and later, overhead transparencies and slides (shown with special projectors). Then followed the era of teaching aids with sounds/voice and included radio, audio tapes and CD's. Soon a combination of the two, audio and visual, was introduced and most new teaching aids are now A/V (audiovisual) in nature. They include television, projectors, VCR and DVD's with actual demonstrations or simplified animations and computers (Power Point presentations).

Biology as a Special Subject that Needs Clear Concepts More than any Other Subject

Since students of human biology eventually have to deal with living fellow beings for one reason or the other, it is imperative that their perception of what goes on inside the human body be absolutely unambiguous. Whether it is for the purpose of prevention or treatment of diseases or enhancement of physical health, a clear concept of basic anatomy and physiology is vital. It is to achieve this goal that teachers and instructors of biology have been very receptive to any new teaching aid but unfortunately they have not been many especially in comparison with pace that human sciences are growing.

### History of Teaching Aids in Biology

In addition to the teaching aids used in other fields of education, biology teachers use special methods to help them make students understand the subject matter in more interesting and practical mariner. These include study of preserved cadaver models, synthetic organ and system models and animal and cadaver dissection. Although these approaches give the students plenty of information yet they are all virtual in nature and remain short of providing a real life concept of organ structure and function.

The problems emanating from this gap between realty and imagination are many folds and affect every one in the field of biology though differently.

Teachers who do not possess a vivid concept lack the very foundation required to gain confidence of their students. Hence they can't pass the truthful information on to the audience. From students' perspective grasp of basic concepts is pivotal to their continued interest and advancement in any subject. Poorly understood concepts create disinterest, halt progress and eventually result in exit from what could have been a very rewarding career.

The role of unambiguous concepts becomes even more important at the peak i.e. for professionals like technologists, biologists, physicians and researchers since they implement their concepts to generate results. And it is obvious that correlating facts, understanding their interlinks and deducing correct results for diagnostic, treatment or research purposes is not likely without a strong and clear understanding of basic concepts.

### Available Teaching Aids:

1. Mostly static—text, sketches, color diagrams, actual photos, preserved cadaver organ models, synthetic models, animal/human dissection.
2. Dynamic—videos, animation
Problems with Current Teaching Aids:

1. None of the aids is real time—atmosphere not based on trust and leaves students in confusion with questions like:
a Is this actually real?
b. Is the living body as simple and colorful?
c. Is the information edited?
d. Do the systems work as independently (of each other) as they are taught?

2. There is insufficient support for truthful concept building in most aids. Even in the best books of biology with excellent color diagrams organs are removed in layers in successive photos to show their positioning and relationship with other organs. But obviously it can not show the relationship with organs that were removed.

3. Most biology teaching aids build concepts outside the human body and in single dimension imagination as separate organs and systems that have to be transported imaginatively inside the body (multi-dimension existence) in practical life.

4. Current teaching aids are not time efficient, both for teachers and students.

5. They are monotonous. Same methods are used by many teachers, class after class creating boredom.

6. They do not inspire students to adopt biology as a career nor generate a drive for professional excellence.

Our Device Overcomes these Problems Because:
1. It forms images of organs and systems exactly as they are positioned inside the human body (real time). This generates a truthful imprint of information in student's mind from the very beginning instead of hypothetical concepts.
2. It provides a three dimensional view of organs as expected in actual dissection and hence helps demonstrate shape, size, relative size, boundaries and relationships with other neighboring tissues.
3. It is portable, clean, elegant and most current.
4. It is lime and cost efficient.
5. It generates strong drive for professional excellence.
6. It is unique, out of monotony, dynamic and leaves a tasting impression.
7. It reduces the need for animal dissection.
8. It has no side effects reported if used within the standard guidelines.

### FUNCTIONAL DETAIL

### System Requirement

A portable ultrasound machine
A transducer
Ultrasound jelly
Projector and screen or Big screen TV
A volunteer subject
Set Up Hook up transducer and projector to machine and power on. Position volunteer subject, apply ultrasound jelly to skin over the desired organ/system.
Start scanning. Image appears on the screen. Begin demo.

### Points to Note:

Picture has real time respiratory movement effect
Picture has depth and width.
Shows exact size, shape, texture and location of organs
Operator can change planes of view (long, short, and oblique)
Shows heart motion, arterial pulsation, gut motility etc
Operator can show blood flow through Doppler

One can see that the picture is large, clear and easily understandable. It comes from an actual human being without any delay or editing leaving no room for ambiguity. There are many new aspects of interest to this picture when compared with a traditional video or animated movie as it shows organs working simultaneously and in harmony yet independently. Color flow provides a whole new wealth of interesting data for the viewer. It not only makes understanding easy but also sparks interest in the subject of biology and sets students' thought process in motion. They ask questions and rewrite their concepts, corrected. Many ask about the road to learn the technique and its

prospects, others decide to dig in deeper in biology and yet others feel convinced that they are now clear about their destination as a physician.

The embodiments of the invention in which an exclusive property or privilege is claimed are defined as follows:

1. A method of teaching biology in schools which comprises a process utilizing:
a. An ultrasound machine
b. A transducer
c. A projector and screen combination
d. An external monitor
e. A human subject
f. An operator
g. Audience

2. The combination defined in claim 1 wherein ‘Subject of Biology’ implies the courses intended to teach normal abnormal functions of organs and systems inside human body at any and all levels. It encompasses courses in general human biology and including but not limited to any of its specific subclasses e.g. zoology, anatomy, physiology, pathology, cardiology, gastroenterology, respirology, nephrology, urology, obstetrics and gynecology, hepatology, endocrinology, kinesiology, rheumatology, male and female reproductive systems, musculoskeletal system, skin and its appendages, breast tissue, skull and its internal structures, blood vessels, fetus and its allied structures, serous cavities and salivary glands.

3. The combination defined in claim 1 wherein ‘Schools’ include:
a. All high schools
b. All colleges
c. All universities
d. All polytechnic institutes
e. All professional training institutions
f. Teacher training programs
g. Private study groups
h. All other institutes and organizations where biology is taught

4. The combination defined in claim 1 wherein the ‘Process’ implies producing cal time ultrasound images in a classroom setting for the purpose of education and training.

5. The combination defined in claim 1 wherein the ‘Process’ is being offered free of charge or for a fee from the participants or their sponsors.

6. The combination defined in claim 1 wherein the ‘ultrasound machine’ refers to an electrically operated computerized system capable of ultrasound data processing in B, M, PW, CW, color and/or 3D/4D modes individually or simultaneously.

7. The combination defined in claim 1 wherein a ‘Transducer’ is a device that, when attached to an ultrasound machine, will transmit and receive ultrasound waves for the purpose of image formation in B, M, PW, CW, color, 3D and 4D modes by the ultrasound machine. A transducer may be square, rectangular, curved or tube like in shape and vary in frequency from 1 to 20 Megahertz.

8. The combination defined in claim 1 wherein ‘Projector and screen’ are well known objects used to display an enlarged image for an audience when connected to an image producing device like an ultrasound machine.

9. The combination defined in claim 1, wherein ‘External Monitor’ is a well known device that when connected to ‘video out’ connectors of an ultrasound machine will display an exact, real time replica of same or larger size of the image seen on the ultrasound machine.

10. The combination defined in claim 1 wherein a ‘Human Subject’ is an adult person who is scanned with ultrasound machine through its transducer during the process.

11. The combination defined in claim 1 wherein an ‘Operator’ is a person who has graduated from an accredited school of medicine and/or is certified to perform ultrasound examination or any person who has obtained expertise to operate the ultrasound machine.

12. The combination defined in claim 1 wherein an ‘Audience’ is an individual or group of individuals gathered to watch the process. Although the process is designed for students and teachers of human biology in high schools, colleges, universities, professional and technical training institutes and any other organization training personnel yet ‘Audience’ also includes any individual or a group of individuals gathered to watch the process.
